(19) United States
(12) Patent Application Publication
(10) Pub. No.: US 2022/0284412 A1
(43) Pub. Date: Sep. 8, 2022

(54) METHOD AND SYSTEM FOR OPTIMIZING POS TERMINALS

(71) Applicant: TOSHIBA TEC KABUSHIKI KAISHA, Tokyo (JP)

(72) Inventors: Krishna Puthran, Bangalore (IN); Sudharsan Reddy Nareddy, Bangalore (IN); Kaarthikeyan Lokanathan, Bangalore (IN)

(73) Assignee: TOSHIBA TEC KABUSHIKI KAISHA, Tokyo (JP)

(21) Appl. No.: 17/541,827

(22) Filed: Dec. 3, 2021

(30) Foreign Application Priority Data
Mar. 3, 2021 (IN) 202141008918

(51) Int. Cl. G06Q 20/20; G06F 1/3296; G06N 20/00

(52) U.S. Cl. CPC G06Q 20/202; G06F 1/3296; G06N 20/00

(57) ABSTRACT

The present disclosure relates to a method and system for operating a plurality of point of sale (POS) terminals of a POS system installed in a store. The system receives current transaction data from a store server and determines a quantity of the POS terminals that are required for at least one of current transactions or future transactions using a model. The model is trained using historical transaction data and usage statistics of the plurality of POS terminals corresponding to the historical transaction data. The system activates or deactivates at least one of the POS terminals such that the determined quantity of the POS terminals are operated to complete the at least one of the current transactions or the future transactions.

### CROSS-REFERENCE TO RELATED APPLICATION

This application claims the benefit of and priority to Indian Patent Application No. 202141008918, filed on Mar. 3, 2021, the entire disclosure of which is hereby incorporated by reference herein.

### TECHNICAL FIELD

The present disclosure relates in general to Point Of Sale (POS) systems. Particularly, but not exclusively, the present disclosure relates to a method and a system for optimizing POS terminals.

### BACKGROUND

A Point Of Sale (POS) system is widely used in retail stores. The POS system helps in efficient billing and analysis of billed items. The POS system is used when customers make payments for goods purchased in a store. The POS system enables seamless operation of billing as the POS system includes various POS terminals which are operated in tandem. The POS terminals generally include a scanner (e.g., bar code, QR code and the like), a payment device (e.g., card reader, or device supporting any other type of payment), a cash drawer, and a receipt printer. The POS terminals are connected to a workstation (e.g., monitor, tablet) which is operated by an operator in the store. The POS system not only provides seamless operation of billing to the operators, but also improves customer interaction as the billing process is completed in a short time period.

Typically, in retail stores, scaling of the POS terminals is performed manually. During increased sales, due to more customers, a greater number of POS terminals are required to provide fast billing to customers. Sharing of POS terminals with a POS workstation helps in scaling. However, usage of the POS terminals is not optimized in the existing stores. Usually, a greater number of POS terminals are operated than required to dynamically equip the POS system when sales shoots up. The POS terminals can be battery operated or can be operated on mains power (e.g., from a connection to a power grid). The continuous usage of the POS terminals consumes a large amount of power and using additional POS terminals results in energy wastage. The current systems do not disclose how to use the POS terminals optimally even with varying sales. Hence, there is a need to optimize the use of the POS terminals while also enabling fast billing according to dynamic variations in sales.

The information disclosed in this background of the disclosure section is only for enhancement of understanding of the general background of the invention and should not be taken as an acknowledgment or any form of suggestion that this information forms the prior art already known to a person skilled in the art.

### SUMMARY

Additional features and advantages are realized through the techniques of the present disclosure. Other embodiments and aspects of the disclosure are described in detail herein and are considered a part of the claimed disclosure.

Disclosed herein is a method of operating a plurality of point of sale (POS) terminals of a POS system installed in a store. The method is performed by a computing system associated with the store. The method comprises receiving current transaction data from a store server in real-time. The current transaction data indicates transactions made by a plurality of customers in the store. Further, the method comprises determining a quantity of the POS terminals that are required for at least one of current transactions or future transactions using a model. The model is trained using historical transaction data and usage statistics of the POS terminals corresponding to the historical transaction data. The method further comprises activating or deactivating at least one of the POS terminals such that the determined quantity of the POS terminals are operated to complete the at least one of the current transactions or the future transactions.

Further, the present disclosure discloses a computing system for operating a plurality of point of sale (POS) terminals of a POS system installed in a store. The computing system comprises one or more processors and a memory containing instructions that, when executed by the one or more processors, cause the one or more processors to perform certain functions. The instructions cause the one or more processors to receive current transaction data from a store server in real-time. The current transaction data indicates transactions made by a plurality of customers in the store.

Further, the instructions cause the one or more processors to determine a quantity of the POS terminals that are required for at least one of current transactions or future transactions using a model. The model is trained using historical transaction data and usage statistics of the plurality of POS terminals corresponding to the historical transaction data. The instructions cause the one or more processors to activate or deactivate at least one of the POS terminals such that the determined quantity of the POS terminals are operated to complete the at least one of the current transactions or the future transactions.

The present disclosure also discloses a non-transitory computer readable medium including instructions stored thereon that when processed by at least one processor cause a device to receive current transaction data from a store server in real-time. The current transaction data indicates transactions made by a plurality of customers in a store. Further, the instructions cause the device to determine a quantity of POS terminals required for at least one of current transactions or future transactions using a model. The model is trained using historical transaction data and usage statistics of the plurality of POS terminals corresponding to the historical transaction data. The instructions cause the device to activate or deactivate at least one of the POS terminals such that the determined quantity of the POS terminals are operated to complete the at least one of the current transactions or the future transactions.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary environment of a POS system, in accordance with some embodiments of the present disclosure;

FIG. 2 is a block diagram of a computing system for optimizing POS terminals, in accordance with some embodiments of the present disclosure;

FIG. 3 is a flowchart illustrating method steps for training an AI model for optimizing POS terminals, in accordance with some embodiments of the present disclosure;

FIG. 4a and FIG. 4b show an exemplary illustration of training the AI model and testing the AI model for optimizing the POS terminals, in accordance with some embodiments of the present disclosure;

FIG. 5 is a flowchart illustrating method steps for optimizing POS terminals during an inference stage of the AI model, in accordance with some embodiments of the present disclosure;

FIG. 6a and FIG. 6b illustrate different scenarios of a store for optimizing POS terminals, in accordance with some embodiments of the present disclosure; and

FIG. 7 shows a general-purpose computer system for optimizing POS terminals, in accordance with embodiments of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and may be described in detail below. It should be understood, however that these examples are not intended to limit the disclosure to the particular forms disclosed, but on the contrary, the disclosure is to cover all modifications, equivalents, and alternatives falling within the scope of the disclosure.

The terms “comprises”, “includes” “comprising”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

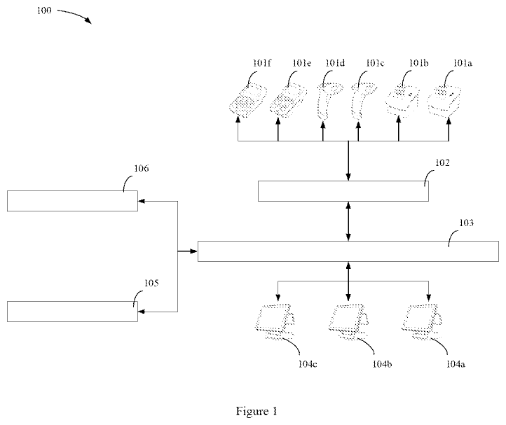

FIG. 1 shows an environment (100) of a Point Of Sale (POS) system. The POS system may be installed in a store (e.g., in a retail store at checkout counters), thus enabling quick and easy checkout for customers. The POS system enables quick billing and checkout for customers, which enriches the experience of the customers. Also, the POS system can be used to track the sales of the store and can be used for analysis. As shown in the FIG. 1, the environment (100) of the POS system comprises a plurality of POS terminals (101a, 101b, . . . , 101n), a terminal manager (102), a network (103), one or more POS workstations (104a, 104b, . . . , 104n), a store server (105) and a computing system (106). The plurality of POS terminals (101a, 101b, 101n) may include a scanner (such as bar code scanner, QR code scanner and the like), a payment device or payment interface (such as a card scanner, a wallet scanner, or a device capable of receiving any other mode of payment), and a receipt printer. In some embodiments, the one or more POS workstations (104a, 104b, . . . , 104n) may also be part of the plurality of POS terminals (101a, 101b, . . . , 101n) in some configurations of the POS system.

In an embodiment, the terminal manager (102) may be configured to operate the plurality of POS terminals (101a, 101b, . . . , 101n). The terminal manager (102) can selectively switch operating modes of the plurality of terminals (101a, 101b, . . . , 101n). For example, the terminal manager (102) can operate the card scanner in an ON mode, the cash drawer in an OFF mode. In some embodiments, the terminal manager (102) may be implemented as a circuit and/or a software in the store server (105) or the computing system (106). The network (103) may be a store network that enables communication between different entities shown in the FIG. 1. The network (103) may be a wired or a wireless network. The wired network can include Ethernet, optical fibers, twisted cables and the like. The wireless network includes Bluetooth, Wireless Fidelity (Wi-Fi), Near Field Communication (NFC), and the like.

In an embodiment, the one or more POS workstations (104a, 104b, . . . , 104n) may include a tablet, a monitor, a phone and the like. The one or more POS workstations (104a, 104b, 104n) may include a POS software. The one or more POS workstations (104a, 104b, . . . , 104n) may be used to initiate a transaction, complete the transaction, control the plurality of POS terminals (101a, 101b, . . . , 101n). For example, when a customer arrives at a checkout counter in a store, a POS workstation (104a) is used to initiate a transaction. The barcode scanner (101c) may be operated to scan the items purchased by the customer. Once items are scanned, the POS workstation (104a) may generate a bill and operate the card scanner (101e) for receiving a payment from the customer. After receiving the payment, the POS workstation (104a) may operate the receipt printer (101a) to print a receipt for the items purchased. Thereby, the entire POS system works in tandem which increases the efficiency of customer checkout.

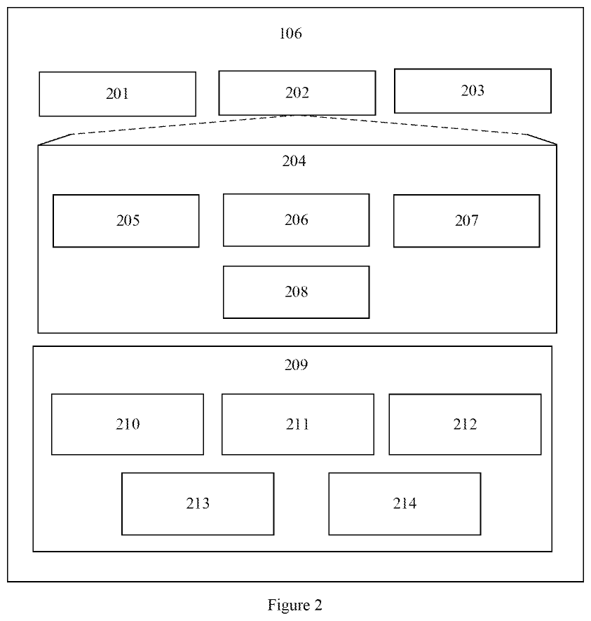

FIG. 2 shows a detailed block diagram of the computing system (106). The computing system (106) (e.g., a control circuit, a computing circuit, a controller, etc.) may include a Central Processing Unit (“CPU” or “processor”) (203) and a memory (202) storing instructions executable by the processor (203). The processor (203) may include at least one data processor for executing program components for executing user or system-generated requests. The memory (202) may be communicatively coupled to the processor (203). The computing system (102) further includes an Input/Output (I/O) interface (201). The I/O interface (201) may be coupled with the processor (203) through which an input signal or/and an output signal may be communicated.

In some implementations, the computing system (106) may include data (204) and modules (209). As an example, the data (204) and modules (209) may be stored in the memory (202) of the computing system (102). In one embodiment, the data (204) may include, for example, POS terminal data (205), transaction data (206), model data (207), and other data (208).

In an embodiment, the POS terminal data (205) may include at least an operating state of the plurality of POS terminals (101a, 101b, . . . , 101c). The operating state of the plurality of terminals can include an ON mode (e.g., an activated state) and/or an OFF mode or a power saving mode (e.g., a deactivated state). The power saving mode can include a sleep mode, a deep sleep mode, a power down mode and a deep power down mode. In an embodiment, the POS terminal data (205) may include current operating state and/or historical operating states. The POS terminal data (205) may further include a number (e.g., a quantity) of POS terminals present in the store. Further, a type of each POS terminal may also be included in the POS terminal data (205).

In an embodiment, the transaction data (206) may include a number of transactions, a timestamp corresponding to each transaction, and a payment mode associated with each transaction.

In an embodiment, the model data (207) may include weight vectors, bias values, hyperparameters of an artificial intelligence (AI) model configured to predict, determine, or estimate a number (e.g., a quantity) of POS terminals required for a plurality of current/future transactions (e.g., current transactions and/or future transactions). The weights and bias values may be updated to update an AI model for predicting the number of POS terminals.

In an embodiment, the other data (208) may include types of transactions, offers provided by financial institutions, and the like.

In some embodiments, data (204) may be stored in the memory (202) in the form of various data structures. Additionally, the data (204) may be organized using data models, such as relational or hierarchical data models. The other data (208) may store data, including temporary data and temporary files, generated by the modules (209) for performing the various functions of the computing system (102).

In some embodiments, the data (204) stored in the memory (202) may be processed by the modules (209) of the computing system (102). The modules (209) may be stored within the memory (202). In an example, the modules (209) that are communicatively coupled to the processor (203) of the computing system (102), may also be present outside the memory (202) as shown in FIG. 2 and implemented as hardware. As used herein, the term modules (209) may refer to an application specific integrated circuit (ASIC), a Field Programmable Gate Array (FPGA), an electronic circuit, a processor (203) (e.g., shared, dedicated, or group), and memory (202) that execute one or more software or firmware programs, a combinational logic circuit, and/or other suitable components that provide the described functionality. In some other embodiments, the modules (209) may be implemented using at least one of ASICs and FPGAs.

In one implementation, the modules (209) may include, for example, a communication module (210), a usage statistics determination module (211), a prediction module (212), a POS terminal operator (213) and other modules (214). It may be appreciated that such aforementioned modules (209) may be represented as a single module or a combination of different modules (209).

In an embodiment, the communication module (210) is used to communicate with the POS system and the store server (105) via the network (103). The communication module (210) may receive the POS terminal data (205), and the transaction data (206) from the store server (105). In an embodiment, the communication module (210) may also communicate the predicted number of POS terminals required for managing current/future transactions.

In an embodiment the usage statistics determination module (211) is used to determine usage statistics of the plurality of POS terminals (101a, 101b, . . . , 101n). The usage statistics determination module (211) uses operating states of the plurality of terminals (101a, 101b, 101n) and correlates the operating states with historical transactions to determine the usage statistics. The usage statistics is used to train the AI model to predict the number of POS terminals.

In an embodiment, the prediction module (212) is used to predict the number of POS terminals required to handle the current/future transactions. During training of the AI model, the prediction module (212) is used to determine a first number (e.g., first quantity, first subset) of the plurality of POS terminals (101a, 101b, . . . , 101n) required to handle the historical transactions using the usage statistics. The first number of the plurality of POS terminals (101a, 101b, . . . , 101n) refers to the number of POS terminals required to handle the historical transactions. Thereafter, the prediction module (212) predicts a second number (e.g., second quantity, second subset) of the plurality of POS terminal required for plurality of test transactions. During training, the AI model is provided with test transactions to test the accuracy of the AI model. The prediction module (212) predicts the second number of POS terminals required to handle the test transactions based on the training. In an embodiment, during inference stage (in real-time) the prediction module predicts the number of POS terminals required to handle current/future transactions.

In an embodiment, the usage statistics determination module (211) and the prediction module (212) together forms the AI model.

In an embodiment the POS terminal operator (213) is used to operate the plurality of POS terminals (101a, 101b, . . . , 101n) based on the prediction. In an embodiment, the POS terminal operator (213) may store POS terminal IDs. Based on the prediction, the POS terminal operator (213) signals the terminal manager (102) via the communication module (210), to operate the predicted POS terminals in an ON mode (e.g., to activate the predicted POS terminals). Further, the POS terminal operator (213) may also provide signals to the terminal manager (102) to operate remaining POS terminals in one of the OFF mode or the power saving mode (e.g., to deactivate the remaining POS terminals). For example, the POS terminal operator (213) may provide the terminal manager (102) with MAC addresses of the POS terminals which has to be operated in the ON mode and MAC addresses of the POS terminals which has to be operated in the OFF mode or the power saving mode.

In an embodiment, the other module (215) may include a notification module, an analysis module, a report generation module, or another type of module. The analysis module may analyze the historical transaction data (206) and predict a status of sales. For example, based on a historical sales trend, the analysis module may predict when the sales may increase or decrease in a calendar year. Likewise, other types of analysis may also be performed and is not limited to analysis of sales alone.

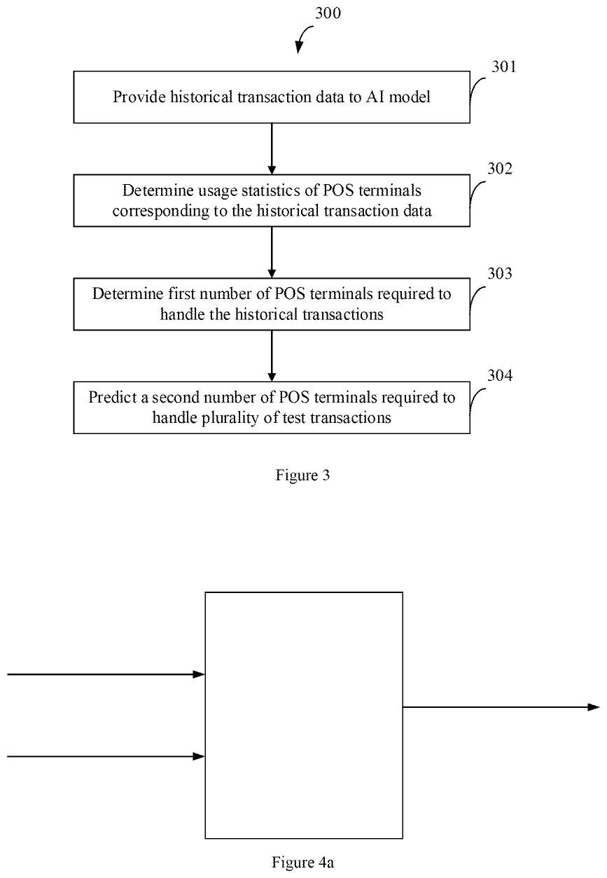

FIG. 3 shows a flowchart illustrating a method of training the AI model for predicting number of POS terminals required to handle transactions, in accordance with some embodiment of the present disclosure. The order in which the method (300) may be described is not intended to be construed as a limitation, and any number of the described method blocks may be combined in any order to implement the method. Additionally, individual blocks may be deleted from the methods without departing from the spirit and scope of the subject matter described herein. Furthermore, the method may be implemented in any suitable hardware, software, firmware, or combination thereof.

At the step (301), the communication module (210) provides the POS terminal data (205) and historical transaction data to the usage statistics determination module (211) of the AI model. The POS terminal data (205) and historical transaction data are obtained from the store server (105). The store server (105) may store the historical transactions in a database (not shown in figure).

At step (302), the usage statistics determination module (211) determines the usage statistics of the plurality of POS terminals (101a, 101b, . . . , 101n) by correlating the operating state of the plurality of POS terminals (101a, 101b, . . . , 101n) with the historical transaction data. For example, the usage statistics determination module (211) determines which of the plurality of POS terminals (101a, 101b, . . . , 101n) had the operating state in the ON mode during the historical transactions. Likewise, the usage statistics determination module (211) determines which of the plurality of POS terminals (101a, 101b, . . . , 101n) had the operating state in the OFF mode or power saving mode during the historical transactions.

At step (303), the prediction module (212) of the AI model determines the first number of POS terminals that were operational during the historical transactions using the usage statistics. The prediction module (212) uses predictive analysis techniques to determine patterns or trends of operating the plurality of POS terminals (101a, 1012, . . . , 101n) according to the historical transactions. In one example, support vector machines may be used to recognize patterns of operating the plurality of POS terminals (101a, 1012, . . . , 101n). In a second example, clustering techniques may be used to cluster transactions for which plurality of POS terminals (101a, 1012, . . . , 101n) were operational. The prediction module (212) may be provided with a large dataset (historical transactions) during training. In some embodiments, supervised or unsupervised techniques may be employed to train the AI model. Further, a timestamp associated with the historical transactions may be used to determine the patterns or trends. For example, the timestamps may indicate that during a festive seasons such as “New Year” the sales are generally high and soon after the festive season the sales are decreased. Hence, for a subsequent calendar year the AI model may be trained accordingly. Likewise, the timestamp and corresponding transaction data (206) may be used to determine patterns or trends in the transactions. In some embodiments, where the checkout counters are based on category of products purchased, further analysis may be made to determine the sales of specific products and thereby train the AI model accordingly. For example, a store may have a first checkout counter specifically for packed products and a second checkout counter specifically for unpacked products. The AI model may be trained to determine the pattern of transactions occurring in the first and second checkout counters.

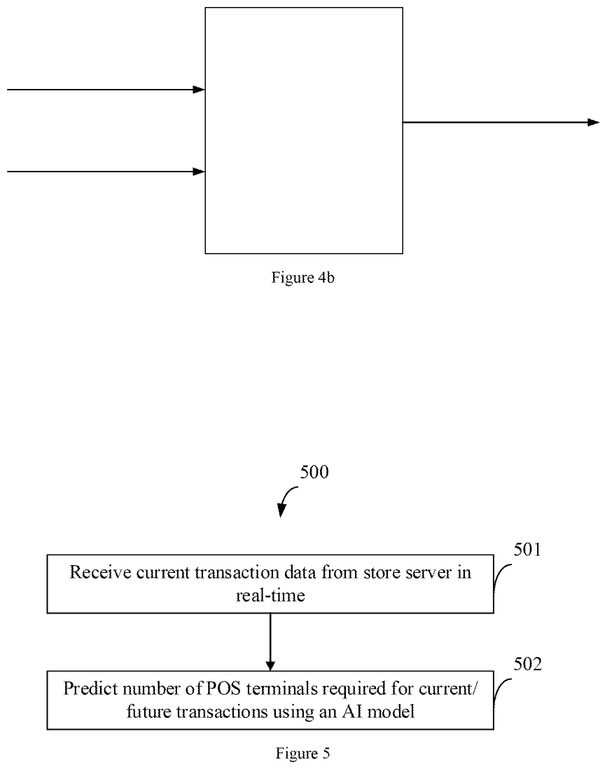

FIG. 4a illustrates an exemplary block diagram of training the AI model. As shown the historical transactions and the operating states of the plurality of POS terminals (101a, 1012, . . . , 101n) is provided as input to the AI model and the AI model outputs the first number of the plurality of POS terminals (101a, 1012, . . . , 101n).

Referring back to FIG. 3, at step (304), the prediction module (212) predicts the second number of the plurality of POS terminals (101a, 1012, . . . , 101n) required to handle test transactions. Once the training data set is provided to the prediction module (212), test transactions may be provided to and the prediction module (212) may be configured to predict the second number of the plurality of POS terminals (101a, 1012, . . . , 101n). Based on the training, the prediction module (212) predicts the second number of the plurality of POS terminals (101a, 1012, . . . , 101n).

FIG. 4b illustrates an exemplary block diagram of testing the AI model. As shown the test transactions and the operating states of the plurality of POS terminals (101a, 1012, . . . , 101n) is provided as input to the AI model and the AI model outputs the second number of the plurality of POS terminals (101a, 1012, . . . , 101n).

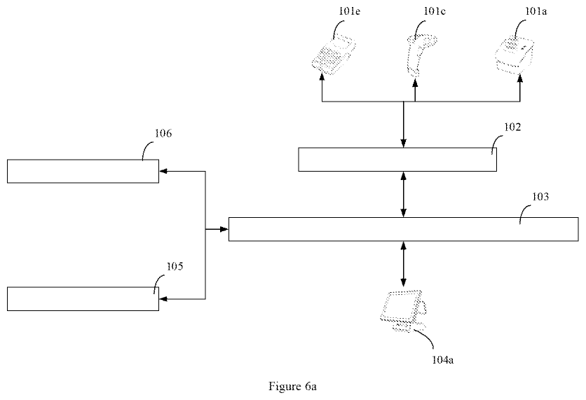

Reference is now made to FIG. 5 which shows method steps (500) for operating the plurality of POS terminals (101a, 1012, . . . , 101n).

At step (501), the computing system (106) receives the current transaction data from the and the current operating states of the plurality of POS terminals (101a, 101b, . . . , 101n) from the store server (105). The current transactions may refer to real-time transactions occurring in the store.

At step (502), the computing system (106) predicts the number of POS terminals from the plurality of POS terminals (101a, 10b, 101n) required to handle the current/future transactions. The computing unit (106) uses the trained AI model to predict the number of the plurality of POS terminals (101a, 101b, . . . 101n) required to handle the current transactions. The AI model may identify patterns in the current transactions and match the identified pattern to patterns identified during the training. The AI model may further determine historical transactions corresponding to the identified patterns and thereafter determine the number of the plurality of POS terminals (101a, 101b, . . . 101n) that were operational corresponding to the historical transactions. Further, the AI model may predict the number of POS terminals required to be operational to handle the current transactions. The AI model may also predict the number of POS terminals that needs to be operated in an OFF mode or the power saving mode based on the current transactions. For example in the case of two specific checkout counters as explained in the above description, the AI model may predict that during festive season the more number of POS terminals is required in the first checkout counter. Hence, few POS terminals in the second checkout counters may be operated in deep sleep mode until the festive season is over, while operating all the POS terminals in the first checkout counter.

Scenario 1:

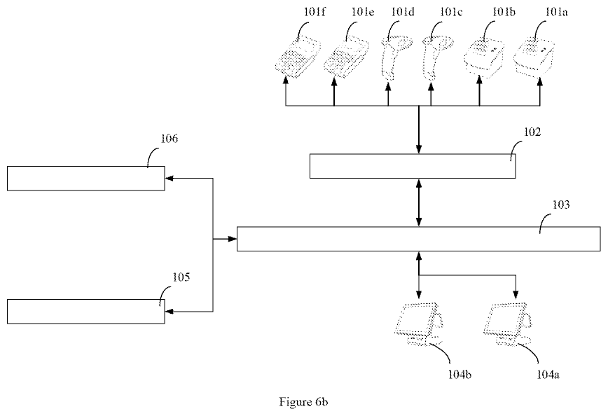

In this scenario, the sales are moderate in a store and it is currently mid-year without any upcoming festive season. Also, the store comprises two sets of each POS terminal. The transactions data are provided to the computing system (106). The computing system (106) receives the transaction data and uses the AI model to predict the number of POS terminals. Based on the historical transactions, the computing system (106) determines that during mid-year the sales are generally moderate as there are no special occasions. Also, the computing system (106) determines the number of POS terminals that were needed during the historical transactions. Based on the analysis, the computing system (106) predicts that one of each POS terminal is required to handle the current transactions. Further, the computing system (106) operates the predicted number of POS terminals in the ON mode and operates rest of the POS terminals in one of the OFF or the power saving mode. FIG. 6a illustrates this scenario.

Scenario 2:

In this scenario, the sales are high in the store and it is currently year-end having Christmas and New Year as a festive season. Also, the store comprises two sets of each POS terminal. The transactions data are provided to the computing system (106). The computing system (106) receives the transaction data and uses the AI model to predict the number of POS terminals. Based on the historical transactions, the computing system (106) determines that during year-end the sales are generally high as there due to the festive occasions. Also, the computing system (106) determines the number of POS terminals that were needed during the historical transactions. Based on the analysis, the computing system (106) predicts that all of the POS terminals are required to handle the current transactions. Further, the computing system (106) operates the predicted number of POS terminals in the ON mode. FIG. 6b illustrates this scenario.

In an embodiment, the present disclosure operates the POS terminals in an optimized way as only required POS terminals are operated and rest of the POS terminals are in OFF mode or power saving mode. The AI model helps to predict the required number of POS terminals accurately and can automatically operate based on the prediction. The present disclosure provides quick and easy scaling of the POS terminals.

### Computer System

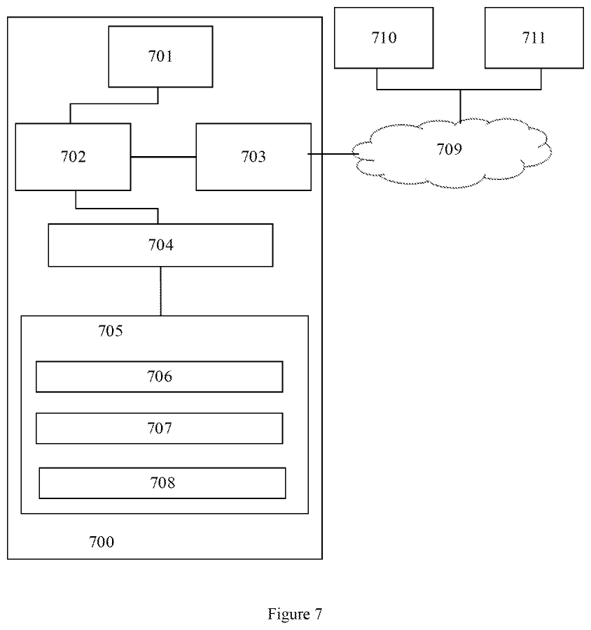

FIG. 7 illustrates a block diagram of an exemplary computer system (700) for implementing embodiments consistent with the present disclosure. In an embodiment, the computer system (700) may be used to implement the method of generating filter sequences to train the model. The computer system (700) may comprise a central processing unit (“CPU” or “processor”) (702). The processor (702) may comprise at least one data processor for executing program components for dynamic resource allocation at run time. The processor (702) may include specialized processing units such as integrated system (bus) controllers, memory management control units, floating point units, graphics processing units, digital signal processing units, etc.

The processor (702) may be disposed in communication with one or more input/output (I/O) devices (not shown) via I/O interface (701). The I/O interface (701) may employ communication protocols/methods such as, without limitation, audio, analog, digital, monoaural, RCA, stereo, IEEE-(1394), serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (701), the computer system (700) may communicate with one or more I/O devices. For example, the input device (710) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (711) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (700) is connected to the service operator through a communication network (709). The processor (702) may be disposed in communication with the communication network (709) via a network interface (703). The network interface (703) may communicate with the communication network (709). The network interface (703) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (709) may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface (703) and the communication network (709), the computer system (700) may communicate with the one or more service operators.

In some embodiments, the processor (702) may be disposed in communication with a memory (705) (e.g., RAM, ROM, etc. not shown in FIG. 7 via a storage interface (704). The storage interface (704) may connect to memory (705) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (705) may store a collection of program or database components, including, without limitation, user interface (706), an operating system (707), web server (708) etc. In some embodiments, computer system (700) may store user/application data (706), such as the data, variables, records, etc. as described in this disclosure. Such databases may be implemented as fault-tolerant, relational, scalable, secure databases such as Oracle or Sybase.

The operating system (707) may facilitate resource management and operation of the computer system (700). Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system (700) may implement a web browser (not shown in Figure) stored program component. The web browser may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers (708) may utilize facilities such as AJAX, DHTML, ADOBE® FLASH®, JAVASCRIPT®, JAVA®, Application Programming Interfaces (APIs), etc. In some embodiments, the computer system (700) may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some embodiments, the computer system (700) may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory (705) on which information or data readable by a processor (702) may be stored. Thus, a computer-readable storage medium may store instructions for execution by one or more processors, including instructions for causing the processors to perform steps or stages consistent with the embodiments described herein. The term “computer-readable medium” should be understood to include tangible items and exclude carrier waves and transient signals, i.e., non-transitory. Examples include Random Access memory (RAM), Read-Only memory (ROM), volatile memory, non-volatile memory, hard drives, Compact Disc (CD) ROMs, Digital Video Disc (DVDs), flash drives, disks, and any other known physical storage media.

In an embodiment, the computer system (700) may comprise remote devices (712). The computer system (700) may receive the first model (104), the second model (105), and the dataset (103) from the remote devices (712) through the communication network (709).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 and FIG. 5 show certain events occurring in a certain order. In alternative embodiments, certain operations may be performed in a different order, modified, or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A method of operating a plurality of point of sale (POS) terminals of a POS system installed in a store, the method comprising:
receiving, by a computing system, current transaction data from a store server in real-time, wherein the current transaction data indicates transactions made by a plurality of customers in the store;
determining, by the computing system, a quantity of the POS terminals that are required for at least one of current transactions or future transactions using a model, wherein the model is trained using historical transaction data and usage statistics of the POS terminals corresponding to the historical transaction data; and
activating or deactivating, by the computing system, at least one of the POS terminals such that the determined quantity of the POS terminals are operated to complete the at least one of the current transactions or the future transactions.

2. The method of claim 1, wherein the model is an artificial intelligence model.

3. The method of claim 1, wherein determining the quantity of the POS terminals includes determining, by the computing system, the quantity of the POS terminals that is required for the future transactions using the model.

4. The method of claim 1, wherein determining, by the computing system, the quantity of the POS terminals includes determining, by the computing system, the quantity of the POS terminals that is required for the current transactions using the model.

5. The method of claim 1, wherein the model is trained by:
providing the historical transaction data from the store server to the model, the historical transaction data relating to a plurality of historical transactions; and
configuring the model to:
determine the usage statistics of the POS terminals corresponding to the historical transaction data;
determine a first quantity of the POS terminals required to handle the historical transactions using the usage statistics; and
determine a second quantity of the POS terminals required for a plurality of test transactions.

6. The method of claim 5, wherein determining the usage statistics includes correlating an operating condition of the POS terminals with the historical transaction data.

7. The method of claim 5, wherein each transaction in the historical transaction data is associated with a timestamp, wherein the model is trained to determine the second quantity of the POS terminals for the plurality of test transactions based on timestamps associated with the plurality of test transactions and the timestamp associated with each transaction in the historical transaction data.

8. The method of claim 1, wherein activating or deactivating the at least one of the POS terminals includes activating or deactivating the at least one of the POS terminals such that (a) the determined quantity of the POS terminals are operated to complete the at least one of the current transactions or the future transactions and (b) the remaining POS terminals are operated in one or more power saving modes.

9. The method of claim 8, wherein the one or more power saving modes include at least one of a sleep mode, a deep sleep mode, a power down mode, or a deep power down mode.

10. A computing system for operating a plurality of point of sale (POS) terminals of a POS system installed in a store, the computing system comprising:
one or more processors; and
a memory containing instructions that, when executed by the one or more processors, cause the one or more processors to:
receive current transaction data from a store server in real-time, wherein the current transaction data indicates transactions made by a plurality of customers in the store;
determine a quantity of the POS terminals that are required for at least one of current transactions or future transactions using a model, wherein the model is trained using historical transaction data and usage statistics of the POS terminals corresponding to the historical transaction data; and
activate or deactivate at least one of the POS terminals such that the determined quantity of the POS terminals are operated during the at least one of the current transactions or the future transactions.

11. The computing system of claim 10, wherein the model is an artificial intelligence model.

12. The computing system of claim 10, wherein the instructions cause the one or more processors to train the model by:
providing the historical transaction data from the store server to the model, the historical transaction data relating to a plurality of historical transactions; and
configuring the model to:
determine the usage statistics of the POS terminals corresponding to the historical transaction data;
determine a first quantity of the POS terminals required to handle the historical transactions using the usage statistics; and
determine a second quantity of the POS terminals required for a plurality of test transactions.

13. The computing system of claim 12, wherein the instructions cause the one or more processors to determine the usage statistics by correlating an operating condition of the POS terminals with the historical transaction data.

14. The computing system of claim 12, wherein the instructions cause the one or more processors to activate or deactivate the at least one of the POS terminals such that (a) the determined quantity of the POS terminals are operated to complete the at least one of the current transactions or the future transactions and (b) the remaining POS terminals are operated in one or more power saving modes.

15. A non-transitory computer readable medium including instructions stored thereon that, when processed by at least one processor, cause a device to:
receive current transaction data from a store server in real-time, wherein the current transaction data indicates transactions made by a plurality of customers in a store;
determine a quantity of POS terminals that are required for at least one of current transactions or future transactions using a model, wherein the model is trained using historical transaction data and usage statistics of the POS terminals corresponding to the historical transaction data; and
activate or deactivate at least one of the POS terminals such that the determined quantity of the POS terminals are operated to complete the at least one of the current transactions or the future transactions.

16. The non-transitory computer readable medium of claim 15, wherein the model is an artificial intelligence model.

17. The non-transitory computer readable medium of claim 15, wherein the model is trained by:
providing the historical transaction data from the store server to the model, the historical transaction data relating to a plurality of historical transactions; and
configuring the model to:
determine the usage statistics of the POS terminals corresponding to the historical transaction data;
determine a first quantity of the POS terminals required to handle the historical transactions using the usage statistics; and
determine a second quantity of the POS terminals required for a plurality of test transactions.

18. The non-transitory computer readable medium of claim 17, wherein determining the usage statistics includes correlating an operating condition of the POS terminals with the historical transaction data.

19. The non-transitory computer readable medium of claim 17, wherein each transaction in the historical transaction data is associated with a timestamp, wherein the model is trained to determine the second quantity of the POS terminals for the plurality of test transactions based on timestamps associated with the plurality of test transactions and the timestamp associated with each transaction in the historical transaction data.

20. The non-transitory computer readable medium of claim 15, wherein activating or deactivating the at least one of the POS terminals includes activating or deactivating the at least one of the POS terminals such that (a) the determined quantity of the POS terminals are operated to complete the at least one of the current transactions or the future transactions and (b) the remaining POS terminals are operated in one or more power saving modes, the one or more power saving modes including at least one of a sleep mode, a deep sleep mode, a power down mode, or a deep power down mode.
